(19) United States
(12) Patent Application Publication
(10) Pub. No.: US 2018/0101882 A1
(43) Pub. Date: Apr. 12, 2018

(54) METHOD AND SERVER FOR PROVIDING ACCEPTANCE MARKS LOCATION INFORMATION

(71) Applicant: MASTERCARD INTERNATIONAL INCORPORATED, Purchase, NY (US)

(72) Inventors: Piyush Sharma, Pune (IN); Elson Rodrigues, Mumbai (IN)

(21) Appl. No.: 15/723,237

(22) Filed: Oct. 3, 2017

(30) Foreign Application Priority Data
Oct. 7, 2016 (SG) 10201608447P

(51) Int. Cl. G06Q 30/06; G06Q 20/22; G06F 17/30

(52) U.S. Cl. CPC G06Q 30/0609; G06F 17/30477; G06Q 20/22

(57) ABSTRACT

According to a first aspect, there is provided a method of providing merchant approved acceptance mark location information, the method comprising: receiving, from a mobile device, a request to determine acceptance marks approved by merchants located within a requested area; querying a database according to the request, the database storing records providing merchant names, corresponding merchant locations and corresponding acceptance marks approved by the merchants, the query identifying merchants located within the requested area, and their corresponding approved acceptance marks; and responding, to the mobile device, with locations of the identified merchants and their corresponding approved acceptance marks.

### TECHNICAL FIELD

The following discloses a method and system that allows location of acceptance marks approved by merchants.

### BACKGROUND

Electronic payment, i.e. making purchases using a payment card, has several advantages over traditional cash payment. For instance, the consumer does not need to ensure that he has sufficient cash to make a purchase. This is particularly useful for items that cost several hundreds, where it may not be safe to carry the large amount of cash required to make the purchase. Further, electronic payment can be bundled with value added services, such as credit card rebates and reward points.

However, electronic payment can only be used provided the merchant systems are able to accept the payment card that a consumer uses to make a purchase. It would be inconvenient should a consumer make a trip to a merchant only to find that they do not accept payment cards belonging to certain acceptance marks, where it is only such payment cards that the consumer has on hand.

There is thus a need to provide consumers with an acceptance mark locator. Other desirable features and characteristics will become apparent from the subsequent detailed description and the appended claims, taken in conjunction with the accompanying drawings and this background of the disclosure.

### SUMMARY OF THE INVENTION

According to a first aspect, there is provided a method of providing merchant approved acceptance mark location information, the method comprising: receiving, from a mobile device, a request to determine acceptance marks approved by merchants located within a requested area; querying a database according to the request, the database storing records providing merchant names, corresponding merchant locations and corresponding acceptance marks approved by the merchants, the query identifying merchants located within the requested area, and their corresponding approved acceptance marks; and responding, to the mobile device, with locations of the identified merchants and their corresponding approved acceptance marks.

According to a second aspect, there is provided an acceptance mark location provider server comprising: at least one processor; and at least one memory including computer program code; an input port coupled to the processor; an output port coupled to the processor the at least one memory and the computer program code configured to, with the at least one processor, cause the server at least to: receive, through the input port, a request from a mobile device to determine acceptance marks approved by merchants located within a requested area; query a database according to the request, the database storing records providing merchant names, corresponding merchant locations and corresponding acceptance marks approved by the merchants, the query identifying merchants located within the requested area and their corresponding approved acceptance marks; and respond, through the output port, to the mobile device with locations of the identified merchants and their corresponding approved acceptance marks.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment, by way of non-limiting example only.

Embodiments of the invention are described hereinafter with reference to the following drawings, in which:

FIG. 1A shows a schematic of a system which allows acceptance marks to be located.

FIG. 1B shows data communication to onboard merchants into an acquirer of the system of FIG. 1A.

FIG. 1C illustrates data communication from an acquirer of the system of FIG. 1A to the acceptance mark location provider server of FIG. 1A.

FIG. 2 shows a schematic of a computing device used to realise the acceptance mark location provider server shown in FIG. 1A that facilitates locating acceptance marks approved by merchants.

FIG. 3 shows a flowchart depicting steps of a method for providing merchant approved acceptance mark location information.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on a computer effectively results in an apparatus that implements the steps of the preferred method.

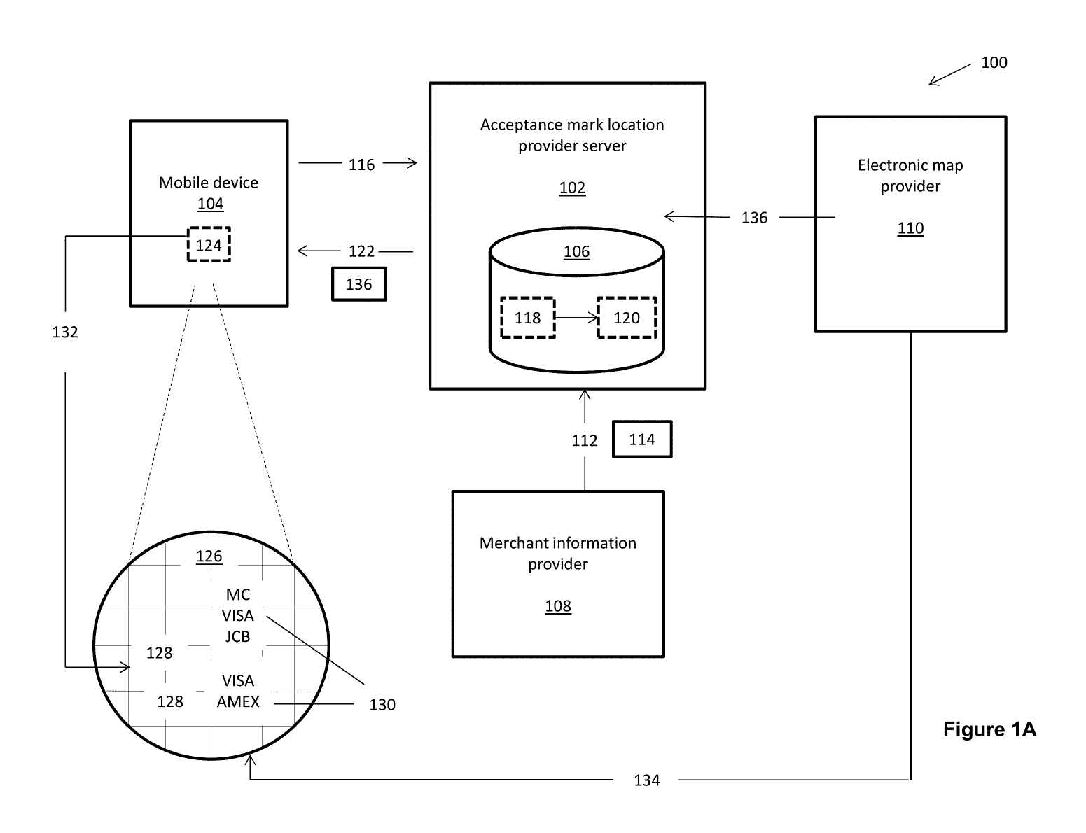

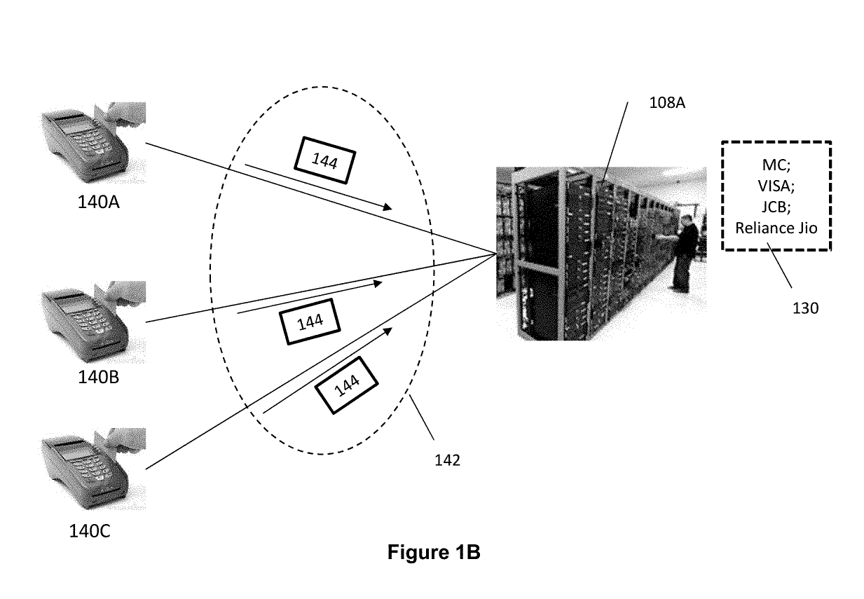

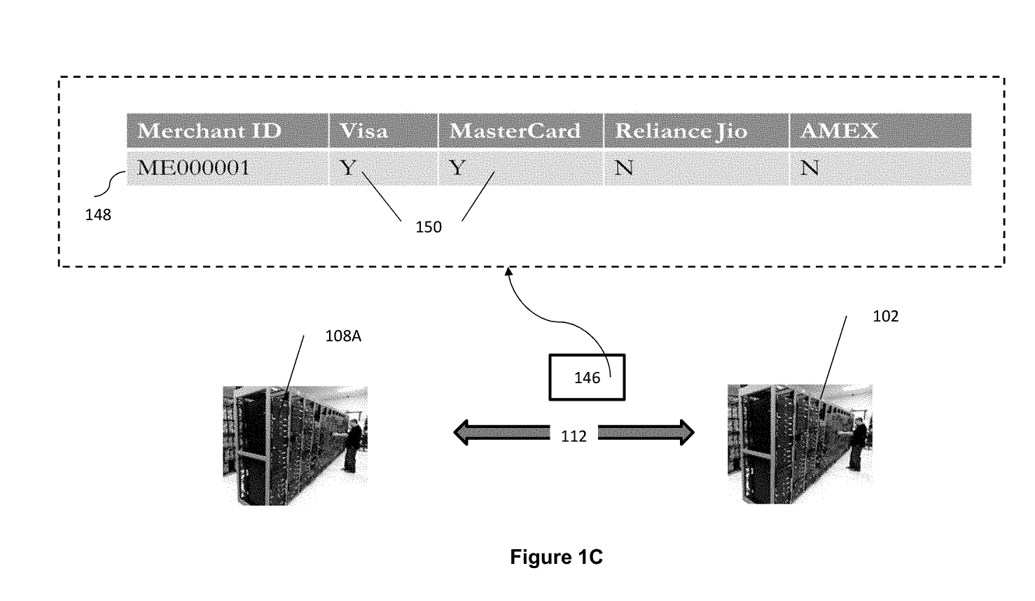

FIG. 1A shows a schematic of a system 100 which allows acceptance marks to be located. Acceptance marks refer to electronic payment card schemes to which a merchant has subscribed, where each of these electronic payment card schemes may use its own proprietary payment protocol to process an electronic payment. For instance, Visa® or MasterCard® uses a four party network system to process a payment transaction made using their card. Acceptance marks are generally represented by a logo or design used by the electronic payment card scheme.

The system 100 seeks to provide merchant approved acceptance mark location information, i.e. a means to identify acceptance marks that are approved by merchants located within an area of interest. For the present disclosure, approved means merchant acceptance of such acceptance marks, i.e. an indication of the payment card schemes that a merchant can process, whereby the customer is able to make an electronic payment at a merchant using a payment card under any of one of these acceptance marks.

The system 100 comprises an acceptance mark location provider server 102, a mobile device 104, a merchant information provider 108 and an electronic map provider 110.

The acceptance mark location provider server 102 hosts the capability to manage records 118 of merchant names, acceptance marks endorsed by these merchants, the location of the merchants and providing these details upon request. These records 118 are data entries stored in a database 106 of the server 102. While these records 118 may be entered through an input terminal of the server 102, they may be automatically provided through an external source, such as the merchant information provider 108.

The merchant information provider 108 serves as a supplier of the data used by the acceptance mark location provider server 102 to derive the records 118 in its database 106, which the acceptance mark location provider server 102 uses to identify acceptance marks that are approved by merchants located within an area of interest. The merchant information provider 108 may refer to one or more servers that provide 112 merchant information 114 to the acceptance mark location provider server 102, the merchant information comprising the data forming the records 118 in the database 106 of the acceptance mark location provider server 102. Merchant information 114 may include data such as names of the merchants registered with the merchant information provider 108, the location of these merchants and the acceptance marks that are approved for making purchases at each of these merchants.

In one implementation, the merchant information provider 108 possesses all this data by, for example, being an acquirer of a four party network system used by Visa® or MasterCard®. In such an implementation, shown in FIG. 1B, the merchant information 114 is generated when onboarding 142 each merchant, whereby a profile for each of the merchant is created and stored. During the onboarding 142, the acquirer 108A is notified of the acceptance marks 130 that each of the merchants 140A, 140B and 140C accept or approve, along with each of the merchants 140A, 140B and 140C name and their location. A data packet 144 received from each of the merchants 140A, 140B and 140C provides, for example in Data Element 2 (DE2), information of payment card schemes loaded into each of the payment terminals of the merchants 140A, 140B and 140C, such information containing issuer identification number (IIN) and bank identification number (BIN) data that allows the identification of the payment schemes supported by the merchants 140A, 140B and 140C. The data packet 144 also provides, for example as DE 41/42, a merchant identifier number (MID) assigned to each merchant 140A, 140B and 140C, the MID providing the merchant 140A, 140B and 140C name and location.

With reference to both FIGS. 1B and 1C, the acquirer 108A creates a bulk file 146 for the information obtained during the onboarding 142 of the merchants 140A, 140B and 140C. This bulk file 146 contains the MIDs for all the onboarded merchants 140A, 140B and 140C and flags to indicate which payment card scheme is supported for each MID . To illustrate, FIG. 1C shows one entry 148 of the bulk file 146, showing that a MID “ME00001” has flags 150 indicating that it accepts Visa® and MasterCard® payment card schemes, but with no indicator that it accepts Reliance Jio® and American Express® payment card schemes. The bulk file 146 is provided 112 to the acceptance mark location provider server 102, so that the acceptance mark location provider server 102 is in receipt of the merchant information 114.

Returning to FIG. 1A, the acceptance mark location provider server 102 communicates with a mobile device 104. One or more of such mobile devices 104 may also simultaneously communicate with the acceptance mark location provider server 102.

The mobile device 104 may be, for example, a mobile terminal such as a laptop computer, smartphone, smartwatch or a tablet with an advanced mobile operating system, such as Windows of Microsoft, iOS of Apple Inc. or Android of Google Inc. The operating system may host one or more mobile applications, including one (represented using the reference numeral 124 in FIG. 1A) that is specifically designed to interface with the server 102 so as to utilise the acceptance mark location service provided by the acceptance mark location provider server 102.

When a consumer wishes to find out what acceptance marks are approved or accepted by merchants within a requested area, the consumer may send a request 116 for such information through the mobile device 104. Such a request 116 may be initiated because the consumer may wish to confirm that at least one of the customer's payment cards, each bearing its own acceptance mark, can be used at the merchants located within the area.

The acceptance mark location provider server 102 queries or interrogates its database 106 according to the received request 116 from the mobile device 104, the query identifying merchants located within the requested area, and their corresponding approved acceptance marks. This is because the database 106 manages the records 118 of merchant names, corresponding merchant locations and corresponding acceptance marks approved by the merchants. Such records 118 are provided by the merchant information provider 108 in the form of the merchant information 114, as explained above. While FIG. 1A shows that the database 106 is hosted within the acceptance mark location provider server 102, it will be appreciated that the database may be hosted in another server (not shown), whereby the acceptance mark location provider server 102 will then communicate with this other server to perform the query or interrogation.

The merchant information 114 received from the merchant information provider 108 may be processed by the acceptance mark location provider server 102 so as to derive the records 118 for its database 106. This processing may involve extracting the merchant names, the locations of these merchants and the corresponding acceptance marks approved by these merchants from the merchant information 114. When processing the received merchant information 114, the acceptance mark location provider server 102 may discover that a merchant may be assigned a merchant identifier for one acceptance mark and a different merchant identifier for another acceptance mark, so that the merchant may have a different merchant identifier for each acceptance mark that the merchant supports. The acceptance mark location provider server 102 may also discover that a merchant may be assigned the same merchant identifier for two different acceptance marks (see, for example, FIG. 1C, which shows that the same merchant identifier, MID 000001, is used by both MasterCard® and Visa®). The acceptance mark location provider server 102 manages all received merchant identifiers (whether different or the same) by determining which of the data indicating the types of acceptance mark approved or accepted by a merchant is matched to the same merchant and then groups such data under the same merchant. That is, the acceptance mark location provider server 102 seeks to compile all of the acceptance marks that a merchant can accept when creating a record in the database 106 for that merchant, whereby that merchant will then have corresponding approved acceptance marks. The database 106 is then populated with these created records.

Since the records 118 in the database 106 contain data entries for merchants which are located outside the requested area provided in the request 116 (i.e. the area where the mobile device 104 is querying the acceptance marks that are approved or accepted), using the request 116 data to query or interrogate the database 106 serves to filter the records 106 to identify merchants located within the requested area of the request 116. The acceptance mark location provider server 102 then responds 122 to the mobile device 104 with response data 136 having the location of the identified merchants and their corresponding approved acceptance marks, i.e. the acceptance mark location provider server 102 provides the mobile device 104 with the results 120 of the filtering performed at the database 106. These results 120 are the merchant names found within the requested area of the request 116, their locations and the payment card schemes that these identified merchants accept. In this manner, the system 100 provides a value add service that facilitates the adoption of electronic payment.

The response data 136 may be in one of several forms. In one implementation, the response data 136 has the location of the identified merchants and their corresponding approved acceptance marks configured as text arranged in a list. Alternatively, the response data 136 has the location of the identified merchants 128 and their corresponding approved acceptance marks 130 configured for display on an electronic map 126 of an area within which the identified merchants 128 is located. This electronic map 126 is shown on a display screen of the mobile device 104.

The implementation of having the response data 136 configured for display on an electronic map 128 may be done in one of three approaches.

In a first approach, the electronic map 128 operates on the mobile device, so that the location of the identified merchants 128 and their corresponding approved acceptance marks 130 are in a data format for display on the electronic map 130. In this first approach, the application 124 in the mobile device 104 initiates another electronic map application to display an electronic map 126 to show the response data 136. Alternatively, the application 124 can cause the mobile device 104 to start its internet browser to access 134 an electronic map provider like Google Maps® (a web planning service developed by Google®), whereby the application 124 overlays 132 the identified merchants 128 and their corresponding approved acceptance marks 130 onto the electronic map 126 streamed into the mobile device 104. Thus, in the first approach, the application 124 provides the processing functionality to locate identified merchants 128 and their corresponding approved acceptance marks 130 on an electronic map 126.

In a second approach, accessing 136 of the electronic map 126 from the electronic map provider 110 is performed by the acceptance mark location provider server 102. The acceptance mark location provider server 102 then determines co-ordinates in the electronic map 126 corresponding to the location of the identified merchants. When the acceptance mark location provider server 102 responds 122 to the mobile device, the mobile device 104 is provided with the electronic map 126 showing the location of the identified merchants 128 and their corresponding approved acceptance marks 130 at the determined co-ordinates. The accessing of the electronic map 126 and the determination of the co-ordinates in the electronic map 126 are performed prior to responding 122 to the mobile device 104.

As opposed to streaming the electronic map 126, in the first and second approaches, the third approach has the acceptance mark location provider server 102 obtain the electronic map 126 through the electronic map provider 110, i.e. the electronic map 126 is downloaded from the electronic map provider 110. This allows the acceptance mark location provider server 102 to modify the electronic map 126 to include the location of the identified merchants and their corresponding approved acceptance marks. When the acceptance mark location provider server 102 responds 122 to the mobile device, the mobile device 104 is provided with the modified electronic map 126. The obtaining of the electronic map 126 and the modification of the electronic map 126 are performed prior to responding 122 to the mobile device 104.

The application 124 with which the mobile device 104 uses to communicate with the system 100 may be downloaded from an application depository, such as Google store® or Apple store®. Registration of the mobile device 104 with the merchant information provider 108, through the application 124, may be required before the application 124 can send the request 116 to the acceptance mark location provider server 102. Alternatively, the application 124 may be embedded as an additional function to an existing application inside the mobile device 104, such as a digital wallet application or a map directory application.

When the consumer makes the request 116, it may be to determine whether any merchants within an area take specific acceptance marks, as opposed to, for example, displaying the electronic map 126 showing all the merchants 128 and their approved acceptance marks 130. To accommodate such determination of specific acceptance marks, the filtering of the records 118 identifies merchants that approve the specific acceptance marks. The response 122 to the mobile device 104 then provides the location of the merchants that approve the specific acceptance marks.

It is also to be noted that the mobile device 104 need not necessarily be in the vicinity of the requested area within which it is desired to locate what merchants are present and the acceptance marks approved or accepted by these merchants, i.e. the request 116 may be made remotely from the requested area. For instance, the consumer may make the request 116 and then decide not to go to the area if it does not have merchants that take at least one of the acceptance marks for the payment cards that the consumer holds. In such a scenario, the requested area indicated in the request 116 is entered into the mobile device 104. Alternatively, the consumer may want to know the payment card schemes that are accepted by merchants in his immediate vicinity. In this alternative scenario, the requested area indicated in the request 116 is determined by a zone in which the mobile device 104 is present.

The acceptance marks that each merchant takes or approves may be different and can comprise any one or more of MasterCard®, Visa®, .American Express®, JCB®, UnionPay® and Diners®.

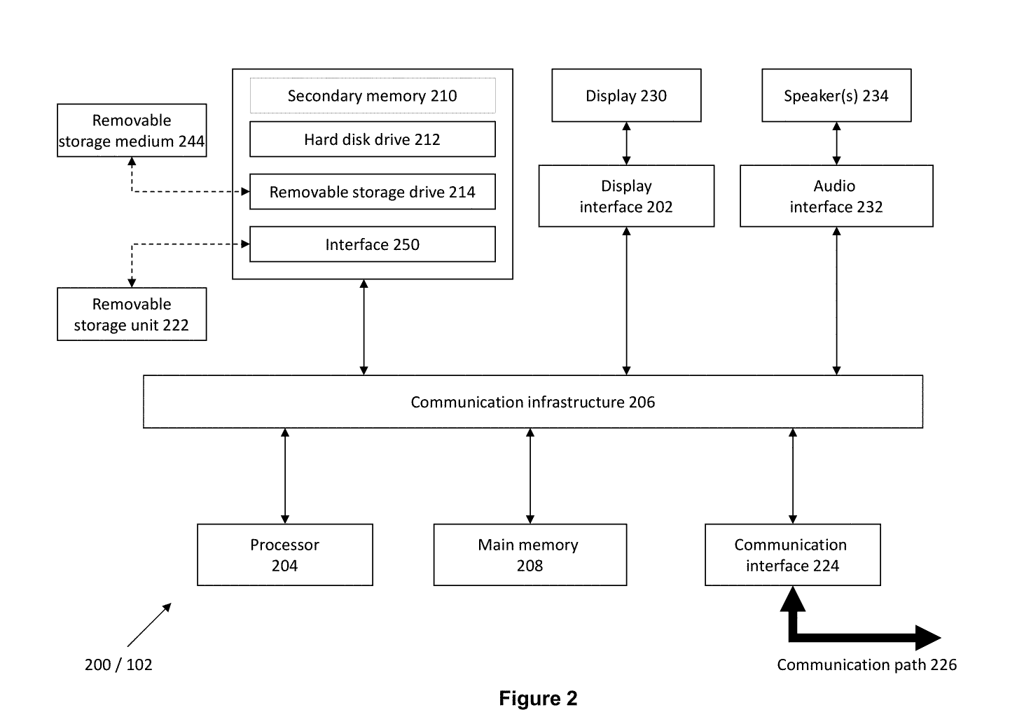

FIG. 2 depicts an exemplary computing device 200, hereinafter interchangeably referred to as a computer system 200, where one or more such computing devices 200 may be used to implement the acceptance mark location provider server 102 shown in FIG. 1A that facilitates identification of acceptance marks that are approved by merchants located within an area of interest. The following description of the computing device 200 is provided by way of example only and is not intended to be limiting.

As shown in FIG. 2, the example computing device 200 includes a processor 204 for executing software routines. Although a single processor is shown for the sake of clarity, the computing device 200 may also include a multi-processor system. The processor 204 is connected to a communication infrastructure 206 for communication with other components of the computing device 200. The communication infrastructure 206 may include, for example, a communications bus, cross-bar, or network.

The computing device 200 further includes a main memory 208, such as a random access memory (RAM), and a secondary memory 210. The secondary memory 210 may include, for example, a storage drive 212, which may be a hard disk drive, a solid state drive or a hybrid drive and/or a removable storage drive 214, which may include a magnetic tape drive, an optical disk drive, a solid state storage drive (such as a USB flash drive, a flash memory device, a solid state drive or a memory card), or the like. The removable storage drive 214 reads from and/or writes to a removable storage medium 244 in a well-known manner. The removable storage medium 244 may include magnetic tape, optical disk, non-volatile memory storage medium, or the like, which is read by and written to by removable storage drive 214. As will be appreciated by persons skilled in the relevant art(s), the removable storage medium 244 includes a computer readable storage medium having stored therein computer executable program code instructions and/or data.

In an alternative implementation, the secondary memory 210 may additionally or alternatively include other similar means for allowing computer programs or other instructions to be loaded into the computing device 200. Such means can include, for example, a removable storage unit 222 and an interface 250. Examples of a removable storage unit 222 and interface 250 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 222 and interfaces 250 which allow software and data to be transferred from the removable storage unit 222 to the computer system 200.

The computing device 200 also includes at least one communication interface 224. The communication interface 224 allows software and data to be transferred between computing device 200 and external devices via a communication path 226. In various embodiments of the inventions, the communication interface 224 permits data to be transferred between the computing device 200 and a data communication network, such as a public data or private data communication network. The communication interface 224 may be used to exchange data between different computing devices 200 which such computing devices 200 form part an interconnected computer network. Examples of a communication interface 224 can include a modem, a network interface (such as an Ethernet card), a communication port (such as a serial, parallel, printer, GPIB, IEEE 1394, RJ45, USB), an antenna with associated circuitry and the like. The communication interface 224 may be wired or may be wireless. Software and data transferred via the communication interface 224 are in the form of signals which can be electronic, electromagnetic, optical or other signals capable of being received by communication interface 224. These signals are provided to the communication interface via the communication path 226.

As shown in FIG. 2, the computing device 200 further includes a display interface 202 which performs operations for rendering images to an associated display 230 and an audio interface 232 for performing operations for playing audio content via associated speaker(s) 234.

As used herein, the term “computer program product” may refer, in part, to removable storage medium 244, removable storage unit 222, a hard disk installed in storage drive 212, or a carrier wave carrying software over communication path 226 (wireless link or cable) to communication interface 224. Computer readable storage media refers to any non-transitory, non-volatile tangible storage medium that provides recorded instructions and/or data to the computing device 200 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 200. Examples of transitory or non-tangible computer readable transmission media that may also participate in the provision of software, application programs, instructions and/or data to the computing device 200 include radio or infra-red transmission channels as well as a network connection to another computer or networked device, and the Internet or Intranets including e-mail transmissions and information recorded on Websites and the like.

The computer programs (also called computer program code) are stored in main memory 208 and/or secondary memory 210. Computer programs can also be received via the communication interface 224. Such computer programs, when executed, enable the computing device 200 to perform one or more features of embodiments discussed herein. In various embodiments, the computer programs, when executed, enable the processor 204 to perform features of the above-described embodiments. Accordingly, such computer programs represent controllers of the computer system 200.

Software may be stored in a computer program product and loaded into the computing device 200 using the removable storage drive 214, the storage drive 212, or the interface 250. The computer program product may be a non-transitory computer readable medium. Alternatively, the computer program product may be downloaded to the computer system 200 over the communications path 226. The software, when executed by the processor 204, causes the computing device 200 to perform perform functions of embodiments described herein.

It is to be understood that the embodiment of FIG. 2 is presented merely by way of example. Therefore, in some embodiments one or more features of the computing device 200 may be omitted. Also, in some embodiments, one or more features of the computing device 200 may be combined together. Additionally, in some embodiments, one or more features of the computing device 200 may be split into one or more component parts. The main memory 208 and/or the secondary memory 201 may serve(s) as the memory for the server 102; while the processor 204 may serve as the processor of the server 102.

The memory (210, 208) for the server 102 contains computer program code, where the memory and the computer program code are configured to, with the processor 204 of the server 102, cause the server 102 at least to: receive, through an input port (such as the communication interface 224), a request from a mobile device to determine acceptance marks approved by merchants located within a requested area. The server 102 is further configured to query or interrogate a database according to the request, the database storing records providing merchants, corresponding merchant locations and corresponding acceptance marks approved by the merchants, the query identifying merchants located within the requested area, and their corresponding approved acceptance marks. This database may be found in the hard disk drive 212 of the server 102. The server 102 is also further configured to filter the records to identify merchants located within the requested area and their corresponding approved acceptance marks; and respond, through an output port (such as the communication interface 224), to the mobile device with locations of the identified merchants and their corresponding approved acceptance marks.

In the scenario where the request comprises a determination of specific acceptance marks, the server 102 may be further configured to filter the records to identify merchants that approve the specific acceptance marks. The server 102 then responds, through the output port, to the mobile device to provide the location of the merchants that approve the specific acceptance marks.

The server 102 may provide the location of the identified merchants and their corresponding approved acceptance marks in a data configuration for display on an electronic map of an area within which the identified merchants is located. This may be implemented in one of three ways.

In a first implementation, the electronic map is operating on the mobile device, so that the location of the identified merchants and their corresponding approved acceptance marks are in a data format for display on the electronic map.

In a second implementation, the server 102 may be configured to access the electronic map through an electronic map provider. The server 102 then determines co-ordinates in the electronic map corresponding to the location of the identified merchants. When responding to the mobile device, the server 102 provides to the mobile device the electronic map showing the location of the identified merchants and their corresponding approved acceptance marks at the determined co-ordinates. Accessing of the electronic map and the determination of the co-ordinates in the electronic map are performed prior to responding to the mobile device.

In a third implementation, the server 102 may be configured to obtain the electronic map through an electronic map provider. The server 102 then modifies the electronic map to include the location of the identified merchants and their corresponding approved acceptance marks. When responding to the mobile device, the server 102 provides the mobile device with the modified electronic map. Obtaining and the modification of the electronic map are performed prior to responding to the mobile device.

The server 102 may be further configured to receive merchant information, upon which the records is derived. The server 102 then processes the merchant information to derive the records and populates the database with the records. Receiving of the merchant information, the processing of the merchant information and the populating of the database are performed prior to receiving the request to determine acceptance marks approved by merchants located within an area.

The merchant information may comprise data on acceptance marks and the merchants that approve each of the acceptance marks. The server 102 is then further configured to process the merchant information to determine which of the acceptance marks are approved by a same merchant; and group these acceptance marks under the same merchant. The acceptance marks may be different and comprise any one or more of MasterCard®, Visa®, American Express®, JCB®, UnionPay® and Diners®.

The server 102 may be further configured to communicate with the mobile device through an application operating on the mobile device, wherein the application is configured to display the location of the identified merchants and their corresponding approved acceptance marks.

The area of the request may be determined by a zone in which the mobile device is present or is entered into the mobile device.

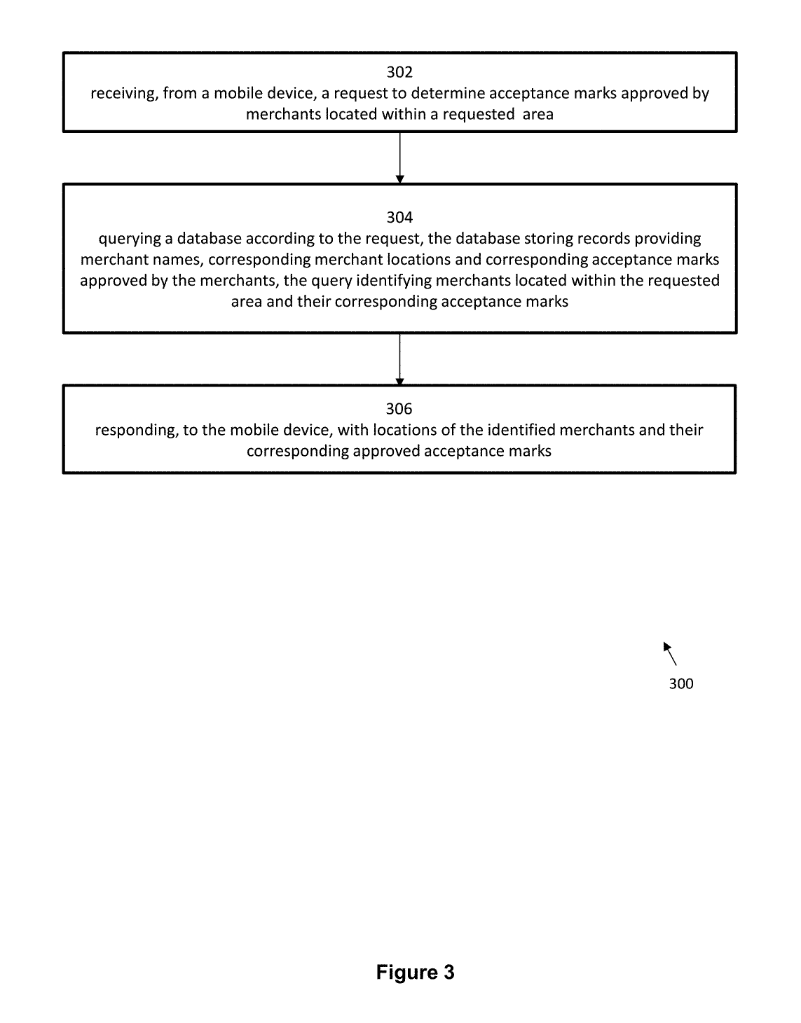

FIG. 3 shows a flowchart depicting steps of a method 300 of providing merchant approved acceptance mark location information. The method 300 is performed by the computing device 200 of FIG. 2.

The method 200 comprises a first step 302 of receiving, from a mobile device, a request to determine acceptance marks approved by merchants located within a requested area.

A second step 304 involves querying a database according to the request, the database storing records providing merchant names, corresponding merchant locations and corresponding acceptance marks approved by the merchants, the query identifying merchants located within the requested area and their corresponding acceptance marks.

A third step 306 involves responding, to the mobile device, with locations of the identified merchants and their corresponding approved acceptance marks.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method of providing merchant approved acceptance mark location information, the method comprising:
receiving, from a mobile device, a request to determine acceptance marks approved by merchants located within a requested area;
querying a database according to the request, the database storing records providing merchant names, corresponding merchant locations and corresponding acceptance marks approved by the merchants, the query identifying merchants located within the requested area, and their corresponding approved acceptance marks; and
responding, to the mobile device, with locations of the identified merchants and their corresponding approved acceptance marks.

2. The method of claim 1, wherein the request comprises a determination of specific acceptance marks, whereby the filtering of the records identifies merchants that approve the specific acceptance marks and whereby the response to the mobile device provides the location of the merchants that approve the specific acceptance marks.

3. The method of claim 2, wherein the location of the identified merchants and their corresponding approved acceptance marks is configured for display on an electronic map of an area within which the identified merchants is located.

4. The method of claim 3, wherein the electronic map is operating on the mobile device, so that the location of the identified merchants and their corresponding approved acceptance marks are in a data format for display on the electronic map.

5. The method of claim 3, further comprising
accessing the electronic map through an electronic map provider,
determining co-ordinates in the electronic map corresponding to the location of the identified merchants, and
providing, when responding to the mobile device, the mobile device with the electronic map showing the location of the identified merchants and their corresponding approved acceptance marks at the determined co-ordinates, wherein the accessing of the electronic map and the determination of the co-ordinates in the electronic map are performed prior to responding to the mobile device.

6. The method of claim 3, further comprising
obtaining the electronic map through an electronic map provider,
modifying the electronic map to include the location of the identified merchants and their corresponding approved acceptance marks, and
providing, when responding to the mobile device, the mobile device with the modified electronic map, wherein the obtaining and the modification of the electronic map are performed prior to responding to the mobile device.

7. The method of claim 1, further comprising, prior to receiving the request
receiving merchant information, upon which the records are derived;
processing the merchant information to derive the records; and
populating the database with the records.

8. The method of claim 7, wherein the merchant information comprises data on acceptance marks and the merchants that approve each of the acceptance marks; and wherein processing the merchant information comprises
determining which of the acceptance marks are approved by a same merchant; and
grouping these acceptance marks under the same merchant.

9. The method of claim 1, wherein communication with the mobile device is through an application operating on the mobile device, wherein the application is configured to display the location of the identified merchants and their corresponding approved acceptance marks.

10. The method of claim 1, wherein the requested area is determined by a zone in which the mobile device is present, or is entered into the mobile device.

11. An acceptance mark location provider server comprising:
at least one processor; and
at least one non-transitory memory including computer program code;
an input port coupled to the processor;
an output port coupled to the processor,
the at least one memory and the computer program code configured to, with the at least one processor, cause the server at least to:
receive, through the input port, a request from a mobile device to determine acceptance marks approved by merchants located within a requested area;
query a database according to the request, the database storing records providing merchant names, corresponding merchant locations and corresponding acceptance marks approved by the merchants, the query identifying merchants located within the requested area and their corresponding approved acceptance marks; and
respond, through the output port, to the mobile device with locations of the identified merchants and their corresponding approved acceptance marks.

12. The server of claim 11, wherein the request comprises a determination of specific acceptance marks, whereby the server is configured to filter the records to identify merchants that approve the specific acceptance marks and respond, through the output port, to the mobile device to provide the location of the merchants that approve the specific acceptance marks.

13. The server of claim 12, wherein the location of the identified merchants and their corresponding approved acceptance marks is configured for display on an electronic map of an area within which the identified merchants is located.

14. The server of claim 13, wherein the electronic map is operating on the mobile device, so that the location of the identified merchants and their corresponding approved acceptance marks are in a data format for display on the electronic map.

15. The server of claim 13, wherein the server is further configured to
access the electronic map through an electronic map provider,
determine co-ordinates in the electronic map corresponding to the location of the identified merchants, and
provide, when responding to the mobile device, the mobile device with the electronic map showing the location of the identified merchants and their corresponding approved acceptance marks at the determined co-ordinates, wherein the accessing of the electronic map and the determination of the co-ordinates in the electronic map are performed prior to responding to the mobile device.

16. The server of claim 13, wherein the server is further configured to
obtain the electronic map through an electronic map provider,
modify the electronic map to include the location of the identified merchants and their corresponding approved acceptance marks, and
provide, when responding to the mobile device, the mobile device with the modified electronic map, wherein the obtaining and the modification of the electronic map are performed prior to responding to the mobile device.

17. The server of claim 11, wherein the server is further configured to:
receive merchant information, upon which the records are derived;
process the merchant information to derive the records; and
populate the database with the records,
wherein the receiving of the merchant information, the processing of the merchant information and the populating of the database are performed prior to receiving the request.

18. The server of claim 17, wherein the merchant information comprises data on acceptance marks and the merchants that approve each of the acceptance marks; and wherein the server is further configured to process the merchant information to
determine which of the acceptance marks are approved by a same merchant; and
group these acceptance marks under the same merchant.

19. The server of claim 11, wherein communication with the mobile device is through an application operating on the mobile device, wherein the application is configured to display the location of the identified merchants and their corresponding approved acceptance marks.

20. The server of claim 11, wherein the requested area is determined by a zone in which the mobile device is present or is entered into the mobile device.
